(19) United States
(12) Patent Application Publication
(10) Pub. No.: US 2022/0328218 A1
(43) Pub. Date: Oct. 13, 2022

(54) NEODYMIUM-IRON-BORON MAGNET MATERIAL, RAW MATERIAL COMPOSITION,PREPARATION METHOD THEREFOR AND USE THEREOF

(71) Applicants: XIAMEN TUNGSTEN CO., LTD., Fujian (CN); FUJIAN CHANGTING GOLDEN DRAGON RARE-EARTH CO., LTD, Fujian (CN)

(72) Inventors: Gang FU, Fujian (CN); Jiaying HUANG, Fujian (CN); Jixiang HUANG, Fujian (CN); Qichen QUAN, Fujian (CN)

(21) Appl. No.: 17/639,758

(22) PCT Filed: Jul. 7, 2020
(86) PCT No.: PCT/CN2020/100586

§ 371 Date: Mar. 2, 2022

(30) Foreign Application Priority Data
Nov. 21, 2019 (CN) 201911150996.3

(51) Int. Cl. H01F 1/057; C22C 38/00

(52) U.S. Cl. CPC H01F 1/057; C22C 38/005; C22C 38/002; C22C 2202/02

(57) ABSTRACT

Disclosed are a neodymium-iron-boron magnet material, a raw material composition, a preparation method therefor and a use thereof. The raw material composition of the neodymium-iron-boron magnet material comprises the following components by mass percentage: 29.5-32% of R′, wherein R′ is a rare earth element and includes Pr and Nd; and Pr≥17.15%; 0.25-1.05% of Ga; 0.9-1.2% of B; and 64-69% of Fe. Without adding a heavy rare earth element to the neodymium-iron-boron magnet material, the remanence and coercive force of the resulting neodymium-iron-boron magnet material are both relatively high.

### TECHNICAL FIELD

The present disclosure relates to neodymium-iron-boron magnet material and raw material composition, preparation method therefor and use thereof.

### BACKGROUND

The neodymium-iron-boron (NdFeB) magnet material with Nd₂Fe₁₄B as the main component has high remanence (referred to as Br), coercive force and maximum energy product (referred to as BHmax), which has excellent comprehensive magnetic properties, and can be used in wind power generation, new energy vehicles, inverter appliances, etc. At present, the rare earth component in the neodymium-iron-boron magnet materials in the prior art is usually mainly neodymium, with only a small amount of praseodymium. At present, although there are a few reports in the prior art that replacing a part of neodymium with praseodymium can improve the performance of the magnet material, the degree of improvement is limited, there is still no significant improvement, and relatively expensive heavy rare earth elements need to be added.

### CONTENT OF THE PRESENT INVENTION

The technical problem to be solved in the present disclosure is for overcoming the defect that the coercive force and remanence of the magnet material cannot be significantly improved after replacing the neodymium with praseodymium partially in the prior art, and the present disclosure provides neodymium-iron-boron magnet material, raw material composition, preparation method therefor and use thereof. The neodymium-iron-boron magnet material in the present disclosure increases the content of praseodymium and gallium at the same time, which can overcome the defect in the prior art that the coercivity cannot be significantly improved by increasing the high praseodymium or the high gallium alone, and the remanence and coercive force of the resulting neodymium-iron-boron magnet material are both relatively high without adding heavy rare earth elements.

The present disclosure solves the above technical problems through the following technical solutions.

The present disclosure also provides a raw material composition of neodymium-iron-boron magnet material, which comprises the following components by mass percentage: 29.5-32% of R′, wherein R′ refers to rare earth elements, R′ comprises Pr and Nd; wherein, Pr≥17.15%;

### 0.25-1.05% of Ga;

### 0.9-1.2% of B;

### 64-69% of Fe;

the percentage refers to the mass percentage of the content of each component in the total mass of the raw material composition of neodymium-iron-boron magnet material.

In the present disclosure, the content of Pr is preferably 17.15-29%, for example 17.15%, 18.15%, 19.15%, 20.15%, 21.15%, 22.15%, 23.15%, 24.15%, 25.15%, 26.15%, 27.15%, 27.85%, or 28.85%, more preferably 20.15-26.15%, the percentage refers to the mass percentage in the total mass of the raw material composition of neodymium-iron-boron magnet material.

In the present disclosure, the content of Nd is preferably 1.85-14%, for example 1.85%, 2.85%, 3.85%, 4.85%, 5.85%, 6.15%, 6.85%, 7.85%, 8.85%, 9.85%, 10.65%, 10.85%, 11.15%, 11.35%, 11.75%, 12.35%, 12.85%, 13.65%, or 13.85%, the percentage refers to the mass percentage in the total mass of the raw material composition of neodymium-iron-boron magnet material.

In the present disclosure, the ratio of the mass of Nd to the total mass of R′ is preferably <0.5, more preferably 0.1-0.45, for example 0.06, 0.08, 0.12, 0.18, 0.2, 0.21, 0.22, 0.24, 0.25, 0.28, 0.29, 0.31, 0.33, 0.35, 0.36, 0.38, 0.39, 0.4, 0.41, 0.41, 0.43 or 0.44.

In the present disclosure, R′ preferably further comprises other rare earth elements other than Pr and Nd, for example Y.

In the present disclosure, R′ preferably further comprises RH, RH refers to heavy rare earth elements; preferably, the kind of RH comprises one or more of Dy, Tb and Ho, more preferably Dy and/or Tb.

Wherein, the mass ratio of RH to R′ is preferably <0.253, more preferably 0-0.07%, for example 0.5/31.5, 0.5/31.8, 1.2/31.2, 1.5/31.5, 1.6/30.9, 1/30.3, 1/30.5, 1/31.9, 1/32, 2.2/31.9, 2/31.3, or 2/32.

Wherein, the content of RH is preferably 1-2.5%, for example 0.5%, 1%, 1.2%, 1.5%, 1.6%, 2% or 2.2%, the percentage refers to the mass percentage in the total mass of the raw material composition of neodymium-iron-boron magnet material.

When RH contains Tb, the content of Tb is preferably 0.5%-2%, for example 0.5%, 0.7%, 0.8%, 1%, 1.2%, 1.4%, 1.5%, 1.7% or 2%, the percentage refers to the mass percentage in the total mass of the raw material composition of neodymium-iron-boron magnet material.

When RH contains Dy, the content of Dy is preferably 1% or less, for example 0.1%, 0.2%, 0.3%, 0.5% or 1%, the percentage refers to the mass percentage in the total mass of the raw material composition of neodymium-iron-boron magnet material.

When RH contains Ho, the content of Ho is preferably 0.8-2%, for example 1%, the percentage refers to the mass percentage in the total mass of the raw material composition of neodymium-iron-boron magnet material.

In the present disclosure, the content of Ga is preferably 0.25-1%, for example 0.25%, 0.27%, 0.28%, 0.29%, 0.3%, 0.31%, 0.32%, 0.33%, 0.35%, 0.36%, 0.37%, 0.38%, 0.39%, 0.4%, 0.41%, 0.43%, 0.45%, 0.47%, 0.49%, 0.5%, 0.51%, 0.53%, 0.55%, 0.57%, 0.6%, 0.7%, 0.8%, 0.85%, 0.9%, 0.95% or 1%, more preferably 0.42-1.05%, the percentage refers to the mass percentage in the total mass of the raw material composition of neodymium-iron-boron magnet material.

In the present disclosure, the content of B is preferably 0.95-1.2%, for example 0.95%, 0.96%, 0.97%, 0.98%, 0.985%, 1%, 1.1%, or 1.2%, the percentage refers to the mass percentage in the total mass of the raw material composition of neodymium-iron-boron magnet material.

In the present disclosure, the content of Fe is preferably 65-68.3%, for example 65.015%, 65.215%, 65.315%, 65.335%, 65.55%, 65.752%, 65.87%, 65.985%, 66.015%, 66.165%, 66.185%, 66.315%, 66.395%, 66.405%, 66.415%, 66.465%, 66.475%, 66.515%, 66.537%, 66.602%, 66.605%, 66.615%, 66.62%, 66.665%, 66.695%, 66.755%, 66.785%, 66.915%, 66.915%, 66.935%, 67.005%, 67.055%, 67.065%, 67.085%, 67.125%, 67.145%, 67.185%, 67.195%, 67.215%, 67.245%, 67.31%, 67.315%, 67.325%, 67.415%, 67.42%, 67.54%, 67.57%, 67.6%, 67.705%, 67.745%, 67.765%, 67.795%, 67.815%, 68.065%, or 68.225%, the percentage refers to the mass percentage in the total mass of the raw material composition of neodymium-iron-boron magnet material.

In the present disclosure, the raw material composition of neodymium-iron-boron magnet material preferably further comprises Cu.

In the present disclosure, the content of Cu is preferably 0.1-0.8%, for example 0.1%, 0.2%, 0.25%, 0.35%, 0.4%, 0.45%, 0.48%, 0.5%, 0.55%, 0.58%, 0.7%, or 0.8%, more preferably 0.1-0.35%, the percentage refers to the mass percentage in the total mass of the raw material composition of neodymium-iron-boron magnet material.

In the present disclosure, the raw material composition of neodymium-iron-boron magnet material preferably further comprises Al.

In the present disclosure, the content of Al is preferably 1% or less, more preferably 0.01-1%, for example 0.02%, 0.03%, 0.05%, 0.1%, 0.12%, 0.15%, 0.2%, 0.3%, 0.4%, 0.45%, 0.6%, 0.8%, or 1%, the percentage refers to the mass percentage in the total mass of the raw material composition of neodymium-iron-boron magnet material.

In the present disclosure, the raw material composition of neodymium-iron-boron magnet material preferably further comprises Zr.

In the present disclosure, the content of Zr is preferably 0.4% or less, for example 0.1%, 0.15%, 0.25%, 0.26%, 0.27%, 0.28%, 0.29%, 0.3%, 0.35%, or 0.4%, more preferably 0.25-0.3%, the percentage refers to the mass percentage in the total mass of the raw material composition of neodymium-iron-boron magnet material.

In the present disclosure, the raw material composition of neodymium-iron-boron magnet material preferably further comprises Co.

In the present disclosure, the content of Co is preferably 0.5-2%, for example 1%, the percentage refers to the mass percentage in the total mass of the raw material composition of neodymium-iron-boron magnet material.

In the present disclosure, the raw material composition of neodymium-iron-boron magnet material preferably further comprises Mn.

Wherein, the content of Mn is preferably 0.02% or less, for example 0.01%, 0.013%, 0.015%, or 0.018%, the percentage refers to the mass percentage in the total mass of the raw material composition of neodymium-iron-boron magnet material.

In the present disclosure, the raw material composition of neodymium-iron-boron magnet material preferably further comprise other elements common in the art, for example one or more of Zn, Ag, In, Sn, V, Cr, Mo, Ta, Hf and W.

Wherein, the content of Zn can be conventional content in the art, preferably 0.1% or less, more preferably 0.01-0.08%, for example 0.01%, 0.04% or 0.06%, the percentage refers to the mass percentage in the total mass of the raw material composition of neodymium-iron-boron magnet material.

Wherein, the content of Mo can be conventional content in the art, preferably 0.1% or less, more preferably 0.01-0.08%, for example 0.03% or 0.06%, the percentage refers to the mass percentage in the total mass of the raw material composition of neodymium-iron-boron magnet material.

In the present disclosure, the raw material composition of neodymium-iron-boron magnet material preferably comprises the following components by mass percentage: 29.5-32% of R′, wherein R′ refers to rare earth elements, R′ comprises Pr and Nd; wherein, Pr≥17.15%; 0.25-1.05% of Ga; Cu≥0.35%; 0.9-1.2% of B; 64-69% of Fe; preferably, R′ further comprises RH, RH refers to heavy rare earth elements, the content of RH is preferably 1-2.5%; the content of Cu is preferably 0.1-0.8%; the content of Pr is preferably 17.15-29%.

In the present disclosure, the raw material composition of neodymium-iron-boron magnet material preferably comprises the following components by mass percentage: 29.5-32% of R′, wherein R′ refers to rare earth elements, R′ comprises Pr and Nd; wherein, Pr≥17.15%; 0.25-1.05% of Ga; Al≤0.03%; 0.9-1.2% of B; 64-69% of Fe; preferably, R′ further comprises RH, RH refers to heavy rare earth elements, the content of RH is preferably 1-2.5%; the content of Pr is preferably 17.15-29%.

In the present disclosure, the raw material composition of neodymium-iron-boron magnet material preferably comprises the following components by mass percentage: 29.5-32% of R′, wherein R′ refers to rare earth elements, R′ comprises Pr and Nd; wherein, Pr≥17.15%; 0.25-1.05% of Ga; 0.25-0.3% of Zr; 0.9-1.2% of B; 64-69% of Fe; preferably, R′ further comprises RH, RH refers to heavy rare earth elements, the content of RH is preferably 1-2.5%; the content of Pr is preferably 17.15-29%.

In the present disclosure, the raw material composition of neodymium-iron-boron magnet material preferably comprises the following components by mass percentage: 29.5-32% of R′, wherein R′ refers to rare earth elements, R′ comprises Pr and Nd; wherein, Pr≥17.15%; 0.25-1.05% of Ga; Cu≥0.35%; Al≤0.03%; 0.9-1.2% of B; 64-69% of Fe; preferably, R′ further comprises RH, RH refers to heavy rare earth elements, the content of RH is preferably 1-2.5%; the content of Cu is preferably 0.1-0.8%; the content of Pr is preferably 17.15-29%.

In the present disclosure, the raw material composition of neodymium-iron-boron magnet material preferably comprises the following components by mass percentage: 29.5-32% of R′, wherein R′ refers to rare earth elements, R′ comprises Pr and Nd; wherein, Pr≥17.15%; 0.25-1.05% of Ga; Cu≥0.35%; 0.25-0.3% of Zr; 0.9-1.2% of B; 64-69% of Fe; preferably, R′ further comprises RH, RH refers to heavy rare earth elements, the content of RH is preferably 1-2.5%; the content of Cu is preferably 0.1-0.8%; the content of Pr is preferably 17.15-29%.

In the present disclosure, the raw material composition of neodymium-iron-boron magnet material preferably comprises the following components by mass percentage: 29.5-32% of R′, wherein R′ refers to rare earth elements, R′ comprises Pr and Nd; wherein, Pr≥17.15%; 0.25-1.05% of Ga; Al≤0.03%; 0.25-0.3% of Zr; 0.9-1.2% of B; 64-69% of Fe; preferably, R′ further comprises RH, RH refers to heavy rare earth elements, the content of RH is preferably 1-2.5%; the content of Pr is preferably 17.15-29%.

In the present disclosure, the raw material composition of neodymium-iron-boron magnet material preferably comprises the following components by mass percentage: 29.5-32% of R′, wherein R′ refers to rare earth elements, R′ comprises Pr and Nd; wherein, Pr≥17.15%; 0.25-1.05% of Ga; Cu≥0.35%; Al≤0.03%; 0.25-0.3% of Zr; 0.9-1.2% of B; 64-69% of Fe; preferably, R′ further comprises RH, RH refers to heavy rare earth elements, the content of RH is preferably 1-2.5%; the content of Cu is preferably 0.1-0.8%; the content of Pr is preferably 17.15-29%.

In the present disclosure, the raw material composition of neodymium-iron-boron magnet material preferably comprises the following components by mass percentage: 29.5-32% of R′, wherein R′ refers to rare earth elements, R′ comprises Pr and Nd; wherein, Pr≥17.15%; 0.25-1.05% of Ga, Mn≤0.02%, 0.9-1.2% of B; 64-69% of Fe; preferably, R′ further comprises RH, RH refers to heavy rare earth elements, the content of RH is preferably 1-2.5%; the content of Pr is preferably 17.15-29%.

In the present disclosure, the raw material composition of neodymium-iron-boron magnet material preferably comprises the following components by mass percentage: 29.5-32% of R′, wherein R′ refers to rare earth elements, R′ comprises Pr and Nd; wherein, Pr≥17.15%; 0.25-1.05% of Ga, Mn≤0.02%, 0.25-0.3% of Zr; 0.9-1.2% of B; 64-69% of Fe; preferably, R′ further comprises RH, RH refers to heavy rare earth elements, the content of RH is preferably 1-2.5%; the content of Pr is preferably 17.15-29%, the content of Ga is preferably 0.8-1%.

In the present disclosure, the percentage refers to the mass percentage of the content of each component in the total mass of the raw material composition of neodymium-iron-boron magnet material.

The present disclosure further provides a preparation method for neodymium-iron-boron magnet material, which employs the above-mentioned raw material composition of neodymium-iron-boron magnet material for preparing.

In the present disclosure, the preparation method comprises the following steps: subjecting the molten liquid of the raw material composition of neodymium-iron-boron magnet material to melting and casting, hydrogen decrepitation, forming, sintering and aging treatment.

In the present disclosure, the molten liquid of the raw material composition of neodymium-iron-boron magnet material can be prepared by conventional methods in the art, for example, by melting in a high-frequency vacuum induction melting furnace. The vacuum degree of the melting furnace can be 5×10⁻² Pa. The temperature of the melting can be 1500° C. or less.

In the present disclosure, the process of the casting can be a conventional casting process in the art, for example: cooling in an Ar gas atmosphere (e.g. in an Ar gas atmosphere of 5.5×10⁴ Pa) at a rate of 10²° C./sec-10⁴° C./sec.

In the present disclosure, the process of the hydrogen decrepitation can be a conventional hydrogen decrepitation process in the art. For example, being subjected to hydrogen absorption, dehydrogenation and cooling treatment.

Wherein, the hydrogen absorption can be carried out under the condition of a hydrogen pressure of 0.15 MPa.

Wherein, the dehydrogenation can be carried out under the condition of heating up while vacuum-pumping.

In the present disclosure, the process of the pulverization after hydrogen decrepitation can be a conventional pulverization process in the art, for example jet mill pulverization. The jet mill pulverization can be preferably carried out under a nitrogen atmosphere with an oxidizing gas content of 150 ppm or less. The oxidizing gas refers to the content of oxygen or moisture. The pressure in the pulverizing chamber of the jet mill pulverization can be preferably 0.38 MPa; the time for the jet mill pulverization can be preferably 3 hours.

Wherein, after the pulverization, a lubricant, for example zinc stearate, can be added to powder according to conventional means in the art. The addition amount of the lubricant can be 0.10-0.15%, for example 0.12%, by weight of the mixed powder.

In the present disclosure, the process of the forming can be a conventional forming process in the art, for example a magnetic field forming method or a hot pressing and hot deformation method.

In the present disclosure, the process of sintering can be a conventional sintering process in the art. For example, preheating, sintering and cooling under vacuum conditions (e.g. under a vacuum of 5×10⁻³ Pa).

Wherein, the temperature of preheating can be 300-600° C. The time of preheating can be 1-2 h. Preferably, the preheating is performed for 1 h at a temperature of 300° C. and 600° C., respectively.

Wherein, the temperature of sintering is preferably 1030-1080° C., for example 1040° C.

Wherein, the time of sintering can be a conventional sintering time in the art, for example 2h.

Wherein, the cooling can be preceded by passing Ar gas to bring the air pressure to 0.1 MPa.

In the present disclosure, after sintering and before the aging treatment, a grain boundary diffusion treatment is preferably further carried out.

Wherein, the grain boundary diffusion treatment can be carried out by a conventional process in the art. For example, substance containing Tb and/or substance containing Dy is attached to the surface of the neodymium-iron-boron magnet material by evaporating, coating or sputtering, and then diffusion heat treatment is carried out.

The substance containing Tb can be a Tb metal, a Tb-containing compound, for example a Tb-containing fluoride or an alloy.

The substance containing Dy can be a Dy metal, a Dy-containing compound, for example a Dy-containing fluoride or an alloy.

The temperature of the diffusion heat treatment can be 800-900° C., for example 850° C.

The time of the diffusion heat treatment can be 12-48 h, for example 24h.

In the present disclosure, in the aging treatment, the temperature of the secondary aging treatment is preferably 460-650° C., for example 500° C.

In the present disclosure, in the secondary aging treatment, the temperature is increased to 460-650° C. preferably at a heating rate of 3-5° C./min. The starting point of the temperature increase can be room temperature.

The present disclosure further provides a neodymium-iron-boron magnet material prepared by the aforementioned preparation method.

The present disclosure provides a neodymium-iron-boron magnet material, which comprise the following components by mass percentage: 29.5-32% of R′, R′ comprises Pr and Nd; wherein, Pr≥17.15%;

### 0.245-1.05% of Ga;

### 0.9-1.2% of B;

### 64-69% of Fe;

the percentage refers to the mass percentage of the content of each component in the total mass of the neodymium-iron-boron magnet material.

In the present disclosure, the content of Pr is preferably 17.15-29%, for example 17.145%, 17.147%, 17.149%, 17.15%, 17.151%, 17.152%, 18.132%, 18.146%, 18.148%, 19.146%, 19.148%, 19.149%, 19.149%, 19.151%, 19.153%, 20.146%, 20.147%, 20.148%, 20.149%, 20.151%, 20.154%, 21.146%, 21.148%, 22.148%, 23.147%, 23.148%, 23.149%, 23.15%, 23.151%, 23.152%, 24.148%, 24.151%, 24.152%, 25.152%, 26.151%, 27.152%, 27.851% or 28.852%, the percentage refers to the mass percentage in the total mass of the neodymium-iron-boron magnet material.

In the present disclosure, the content of Nd is preferably 1.85-14%, for example 1.852%, 2.848%, 3.848%, 4.852%, 5.845%, 5.848%, 5.85%, 5.851%, 5.852%, 6.147%, 6.148%, 6.149%, 6.151%, 6.846%, 6.847%, 6.848%, 6.853%, 7.846%, 7.849%, 7.851%, 7.852%, 8.851%, 9.549%, 9.848%, 9.851%, 9.852%, 10.651%, 10.848%, 10.849%, 10.851%, 11.148%, 11.149%, 11.352%, 11.355%, 11.746%, 11.747%, 11.748%, 11.751%, 11.752%, 12.345%, 12.347%, 12.35%, 12.451%, 12.848%, 12.851%, 12.89%, 13.348%, 13.651%, 13.848%, 13.849% or 13.856%, the percentage refers to the mass percentage in the total mass of the neodymium-iron-boron magnet material.

In the present disclosure, the ratio of the mass of Nd to the total mass of R′ is preferably <0.5, more preferably 0.06-0.45, for example 0.06, 0.08, 0.12, 0.18, 0.2, 0.21, 0.22, 0.24, 0.25, 0.28, 0.29, 0.31, 0.33, 0.35, 0.36, 0.38, 0.39, 0.4, 0.41, 0.41, 0.43 or 0.44.

In the present disclosure, R′ preferably further comprises other rare earth elements other than Pr and Nd, for example Y.

In the present disclosure, R′ preferably further comprises RH, RH refers to heavy rare earth elements, the kind of RH preferably comprises one or more of Dy, Tb and Ho, for example Dy and/or Tb.

Wherein, the mass ratio of RH to R′ is preferably <0.253, more preferably 0.01-0.07, for example, 0.01, 0.02, 0.03, 0.04, 0.05, 0.06 or 0.07.

Wherein, the content of RH is preferably 1-2.5%, for example, 0.421%, 0.501%, 0.502%, 0.503%, 0.51%, 0.99%, 1.004%, 1.005%, 1.006%, 1.01%, 1.02%, 1.03%, 1.212%, 1.223%, 1.512%, 1.521%, 1.593%, 1.604%, 2.001%, 2.002%, 2.01% or 2.253%, the percentage refers to the mass percentage in the total mass of the neodymium-iron-boron magnet material.

When RH contains Tb, the content of Tb is preferably 0.5%-2.01%, for example 0.501%, 0.502%, 0.503%, 0.702%, 0.703%, 0.704%, 0.705%, 0.802%, 1.01%, 1.02%, 1.03%, 1.21%, 1.402%, 1.42%, 1.492%, 1.701%, 2.001% or 2.01%, the percentage refers to the mass percentage in the total mass of the neodymium-iron-boron magnet material.

When RH contains Dy, the content of Dy is preferably 1.05% or less, more preferably 0.1-1.03%, for example 0.101%, 0.202%, 0.203%, 0.301%, 0.302%, 0.303%, 0.421%, 0.51% or 1.03%, the percentage refers to the mass percentage in the total mass of the neodymium-iron-boron magnet material.

When RH contains Ho, the content of Ho is preferably 0.8-2%, for example 0.99%, 1.01% or 1.02%, the percentage refers to the mass percentage in the total mass of the neodymium-iron-boron magnet material.

In the present disclosure, the content of Ga is 0.247-1.03%, for example 0.247%, 0.248%, 0.249%, 0.251%, 0.252%, 0.268%, 0.281%, 0.291%, 0.3%, 0.301%, 0.302%, 0.303%, 0.312%, 0.323%, 0.332%, 0.351%, 0.352%, 0.361%, 0.362%, 0.371%, 0.38%, 0.392%, 0.402%, 0.413%, 0.433%, 0.45%, 0.451%, 0.452%, 0.471%, 0.472%, 0.491%, 0.492%, 0.502%, 0.512%, 0.531%, 0.55%, 0.551%, 0.572%, 0.589%, 0.6%, 0.602%, 0.701%, 0.703%, 0.712%, 0.791%, 0.804%, 0.82%, 0.848%, 0.892%, 0.912%, 0.951%, 1.02% or 1.03%, the percentage refers to the mass percentage in the total mass of the neodymium-iron-boron magnet material.

In the present disclosure, the content of B is 0.95-1.2%, for example 0.949%, 0.956%, 0.969%, 0.982%, 0.983%, 0.984%, 0.985%, 0.986%, 0.987%, 0.991%, 1.02%, 1.11%, 1.18% or 1.19%, the percentage refers to the mass percentage in the total mass of the neodymium-iron-boron magnet material.

In the present disclosure, the content of Fe is 64.8-68.2%, for example, 64.981%, 65.157%, 65.296%, 65.308%, 65.54%, 65.729%, 65.849%, 65.9895, 66.002%, 66.15%, 66.209%, 66.296%, 66.392%, 66.393%, 66.404%, 66.445%, 66.451%, 66.458, 66.503%, 66.532%, 66.595%, 66.607%, 66.6145, 66.62%, 66.644%, 66.664%, 66.756%, 66.782%, 66.909%, 66.912%, 66.913%, 66.941%, 67.007%, 67.058%, 67.072%, 67.093%, 67.125%, 67.14%, 67.187%, 67.188%, 67.195%, 67.247%, 67.267%, 67.279%, 67.294%, 67.327%, 67.347%, 67.405%, 67.425, 67.468, 67.47%, 67.517%, 67.535%, 67.571%, 67.6%, 67.621%, 67.667%, 67.739%, 67.769%, 67.801%, 67.813%, 67.816%, 68.07% or 68.143%, the percentage refers to the mass percentage in the total mass of the neodymium-iron-boron magnet material.

In the present disclosure, the neodymium-iron-boron magnet material preferably further comprises Cu.

In the present disclosure, the content of Cu is preferably 0.1-0.9%, for example, 0.1%, 0.102%, 0.202%, 0.205%, 0.25%, 0.351%, 0.352%, 0.402%, 0.405%, 0.451%, 0.452%, 0.481%, 0.5, 0.501, 0.502%, 0.552%, 0.581%, 0.7% or 0.803%, the percentage refers to the mass percentage in the total mass of the neodymium-iron-boron magnet material.

In the present disclosure, the neodymium-iron-boron magnet material preferably further comprises Al.

In the present disclosure, the content of Al is preferably 1.1 wt % or less, more preferably 0.01-1.02%, for example 0.01%, 0.02%, 0.03%, 0.04%, 0.05%, 0.101%, 0.102%, 0.12%, 0.15%, 0.202%, 0.301%, 0.402%, 0.451%, 0.601%, 0.602%, 0.603%, 0.801% or 1.02%, the percentage refers to the mass percentage in the total mass of the neodymium-iron-boron magnet material.

In the present disclosure, the neodymium-iron-boron magnet material preferably further comprises Zr.

In the present disclosure, the content of Zr is preferably 0.4% or less, for example, 0.1%, 0.15%, 0.248%, 0.25%, 0.251%, 0.252%, 0.26%, 0.27%, 0.28%, 0.29%, 0.3%, 0.301%, 0.302%, 0.35% or 0.4%, more preferably 0.25-0.3%, the percentage refers to the mass percentage in the total mass of the neodymium-iron-boron magnet material.

In the present disclosure, the neodymium-iron-boron magnet material preferably further comprises Co.

Wherein, the content of Co is preferably 0.5-2%, for example 1%.

In the present disclosure, the neodymium-iron-boron magnet material preferably further comprises Mn.

Wherein, the content of Mn is preferably 0.02% or less, for example 0.01%, 0.013%, 0.014%, 0.015%, 0.018% or 0.02%, the percentage refers to the mass percentage in the total mass of the neodymium-iron-boron magnet material.

In the present disclosure, the neodymium-iron-boron magnet material further comprises 0.

Wherein, the content of 0 is preferably 0.13% or less.

In the present disclosure, the neodymium-iron-boron magnet material further comprise other elements common in the art, for example one or more of Zn, Ag, In, Sn, V, Cr, Mo, Ta, Hf and W.

Wherein, the content of Zn can be a conventional content in the art, preferably 0.1% or less, more preferably 0.01-0.08%, for example 0.01%, 0.04% or 0.06%.

Wherein, the content of Mo can be a conventional content in the art, preferably 0.1% or less, more preferably 0.01-0.08%, for example 0.03% or 0.06%.

In the present disclosure, the neodymium-iron-boron magnet material preferably comprises the following components by mass percentage: 29.5-32% of R′, R′ refers to rare earth elements, R′ comprises Pr and Nd; wherein, Pr≥17.15%; 0.245-1.05% of Ga; Cu≥0.35%; 0.9-1.2% of B; 64-69% of Fe; preferably, R′ further comprises RH, RH refers to heavy rare earth elements, the content of RH is preferably 1-2.5%; the content of Cu is preferably 0.1-0.9%; the content of Pr is preferably 17.15-29%.

In the present disclosure, the neodymium-iron-boron magnet material preferably comprises the following components by mass percentage: 29.5-32% of R′, R′ refers to rare earth elements, R′ comprises Pr and Nd; wherein, Pr≥17.15%; 0.245-1.05% of Ga; Al≤0.03%; 0.9-1.2% of B; 64-69% of Fe; preferably, R′ further comprises RH, RH refers to heavy rare earth elements, the content of RH is preferably 1-2.5%; the content of Pr is preferably 17.15-29%.

In the present disclosure, the neodymium-iron-boron magnet material preferably comprises the following components by mass percentage: 29.5-32% of R′, R′ refers to rare earth elements, R′ comprises Pr and Nd; wherein, Pr≥17.15%; 0.245-1.05% of Ga; 0.25-0.3% of Zr; 0.9-1.2% of B; 64-69% of Fe; preferably, R′ further comprises RH, RH refers to heavy rare earth elements, the content of RH is preferably 1-2.5%; the content of Pr is preferably 17.15-29%.

In the present disclosure, the neodymium-iron-boron magnet material preferably comprises the following components by mass percentage: 29.5-32% of R′, R′ refers to rare earth elements, R′ comprises Pr and Nd; wherein, Pr≥17.15%; 0.245-1.05%% of Ga; Cu≥0.35%; Al≤0.03%; 0.9-1.2% of B; 64-69% of Fe; preferably, R′ further comprises RH, RH refers to heavy rare earth elements, the content of RH is preferably 1-2.5%; the content of Cu is preferably 0.1-0.9%; the content of Pr is preferably 17.15-29%.

In the present disclosure, the neodymium-iron-boron magnet material preferably comprises the following components by mass percentage: 29.5-32% of R′, R′ refers to rare earth elements, R′ comprises Pr and Nd; wherein, Pr≥17.15%; 0.245-1.05% of Ga; Cu≥0.35%; 0.25-0.3% of Zr; 0.9-1.2% of B; 64-69% of Fe; preferably, R′ further comprises RH, RH refers to heavy rare earth elements, the content of RH is preferably 1-2.5%; the content of Cu is preferably 0.1-0.9%; the content of Pr is preferably 17.15-29%.

In the present disclosure, the neodymium-iron-boron magnet material preferably comprises the following components by mass percentage: 29.5-32% of R′, R′ refers to rare earth elements, R′ comprises Pr and Nd; wherein, Pr≥17.15%; 0.245-1.05% of Ga; Al≤0.03%; 0.25-0.3% of Zr, 0.9-1.2% of B; 64-69% of Fe; preferably, R′ further comprises RH, RH refers to heavy rare earth elements, the content of RH is preferably 1-2.5%; the content of Pr is preferably 17.15-28.85%.

In the present disclosure, the neodymium-iron-boron magnet material preferably comprises the following components by mass percentage: 29.5-32% of R′, R′ refers to rare earth elements, R′ comprises Pr and Nd; wherein, Pr≥17.15%; 0.245-1.05% of Ga; Cu≥0.35%; Al≤0.03%; 0.25-0.3% of Zr; 0.9-1.2% of B; 64-69% of Fe; preferably, R′ further comprises RH, RH refers to heavy rare earth elements, the content of RH is preferably 1-2.5%; the content of Cu is preferably 0.1-0.9%; the content of Pr is preferably 17.15-29%.

In the present disclosure, the neodymium-iron-boron magnet material preferably comprises the following components by mass percentage: 29.5-32% of R′, R′ refers to rare earth elements, R′ comprises Pr and Nd; wherein, Pr≥17.15%; 0.245-1.05% of Ga; Mn≤0.02%; 0.9-1.2% of B; 64-69% of Fe; preferably, R′ further comprises RH, RH refers to heavy rare earth elements, the content of RH is preferably 1-2.5%; the content of Pr is preferably 17.15-29%.

In the present disclosure, the neodymium-iron-boron magnet material preferably comprises the following components by mass percentage: 29.5-32% of R′, R′ refers to rare earth elements, R′ comprises Pr and Nd; wherein, Pr≥17.15%; 0.245-1.05% of Ga; Mn≤0.02%; 0.25-0.3% of Zr; 0.9-1.2% of B; 64-69% of Fe; preferably, R′ further comprises RH, RH refers to heavy rare earth elements, the content of RH is preferably 1-2.5%; the content of Pr is preferably 17.15-29%; the content of Ga is preferably 0.8-1%.

In the present disclosure, the percentage refers to the mass percentage of the content of each component in the total mass of neodymium-iron-boron magnet material.

The present disclosure provides a neodymium-iron-boron magnet material, in the intergranular triangle region of the neodymium-iron-boron magnet material, the ratio of the total mass of Pr and Ga to the total mass of Nd and Ga is ≤1.0; at the grain boundary of the neodymium-iron-boron magnet material, the ratio of the total mass of Pr and Ga to the total mass of Nd and Ga is ≥0.1; preferably, the components of the neodymium-iron-boron magnet material are defined as the components of the above neodymium-iron-boron magnet material.

In the present disclosure, the grain boundary refers to the boundary between two grains, the intergranular triangle region refers to the gap formed by three or more grains.

The present disclosure provides a use of the above neodymium-iron-boron magnet material as an electronic component in a motor.

In the present disclosure, the motor is preferably a new energy vehicle drive motor, an air-conditioning compressor or an industrial servo motor, a wind turbine generator, an energy-saving elevator or a speaker assembly.

Based on the common sense in the field, the preferred conditions of the preparation methods can be combined arbitrarily to obtain preferred examples of the present disclosure.

The reagents and raw materials used in the present disclosure are commercially available.

The positive progress of the present invention is as follows: in the prior art, adding praseodymium and gallium to the neodymium-iron-boron magnet material can increase the coercivity, but reduce the remanence at the same time. The inventor provided a large number of experiments and found that the compatibility of specific content of praseodymium and gallium can produce a synergistic effect, that is, adding specific content of praseodymium and gallium at the same time can significantly improve the coercivity of neodymium-iron-boron magnet material, and only slightly reduce the remanence. And the remanence and coercive force of the magnet material in the present disclosure are both relatively high without adding heavy rare earth elements.

### BRIEF DESCRIPTION OF THE DRAWINGS

FIG. 1 shows the element distribution diagram formed by FE-EPMA surface scan of the neodymium-iron-boron magnet material prepared in Example 23.

FIG. 2 shows the element distribution diagram at the grain boundary of the neodymium-iron-boron magnet material prepared in Example 23, and 1 in the figure shows the point taken by quantitative analysis at the grain boundary.

FIG. 3 shows the element distribution diagram of the intergranular triangular region of the neodymium-iron-boron magnet material prepared in Example 23, and 1 in the figure shows the point taken by quantitative analysis in the intergranular triangular region.

### DETAILED DESCRIPTION OF THE PREFERRED EMBODIMENT

The following examples further illustrate the present disclosure, but the present disclosure is not limited thereto. Experiment methods in which specific conditions are not indicated in the following embodiments are selected according to conventional methods and conditions, or according to the product specification. The wt. % in the following tables refers to the mass percentage of the content of each component in the total mass of the raw material composition of neodymium-iron-boron magnet material, and “I” indicates that the element was not added. “Br” refers to the residual magnetic flux density and “Hcj” refers to the intrinsic coercivity.

The formulations of the raw material compositions of the neodymium-iron-boron magnet material in the examples and the comparative examples are shown in Table 1 below.

TABLE 1
Formulations for the raw material compositions of the neodymium-iron-boron
magnet materials in the examples and the comparative examples (wt. %)

| No. | Nd | Pr | Dy | Tb | Ho | Ga | Cu | Al | Zr | Co | Mn | Zn | Mo | B | Fe |
|---|---|---|---|---|---|---|---|---|---|---|---|---|---|---|---|
| 1 | 13.85 | 17.15 | / | / | / | 0.25 | / | / | / | / | / | / | / | 0.985 | 67.765 |
| 2 | 13.85 | 17.15 | / | / | / | 0.27 | / | / | / | / | / | / | / | 0.985 | 67.745 |
| 3 | 12.35 | 18.15 | / | / | / | 0.29 | / | / | / | / | / | / | / | 0.985 | 68.225 |
| 4 | 12.85 | 18.15 | / | / | / | 0.31 | / | / | / | / | / | / | / | 0.985 | 67.705 |
| 5 | 12.35 | 19.15 | / | / | / | 0.33 | / | / | / | / | / | / | / | 0.985 | 67.185 |
| 6 | 12.85 | 19.15 | / | / | / | 0.35 | / | / | / | / | / | / | / | 0.985 | 66.665 |
| 7 | 11.35 | 20.15 | / | / | / | 0.37 | / | / | / | / | / | / | / | 0.985 | 67.145 |
| 8 | 11.35 | 20.15 | / | / | / | 0.39 | / | / | / | / | / | / | / | 0.985 | 67.125 |
| 9 | 10.85 | 21.15 | / | / | / | 0.41 | / | / | / | / | / | / | / | 0.985 | 66.605 |
| 10 | 10.65 | 21.15 | / | / | / | 0.43 | / | / | / | / | / | / | / | 0.985 | 66.785 |
| 11 | 8.85 | 22.15 | / | / | / | 0.45 | / | / | / | / | / | / | / | 0.95 | 67.6 |
| 12 | 7.85 | 23.15 | / | / | / | 0.47 | / | / | / | / | / | / | / | 0.96 | 67.57 |
| 13 | 6.85 | 24.15 | / | / | / | 0.49 | / | / | / | / | / | / | / | 0.97 | 67.54 |
| 14 | 5.85 | 25.15 | / | / | / | 0.6 | / | / | / | / | / | / | / | 0.98 | 67.42 |
| 15 | 4.85 | 26.15 | / | / | / | 0.7 | / | / | / | / | / | / | / | 0.99 | 67.31 |
| 16 | 3.85 | 27.15 | / | / | / | 0.8 | / | / | / | / | / | / | / | 0.985 | 67.215 |
| 17 | 2.85 | 27.85 | / | / | / | 0.9 | / | / | / | / | / | / | / | 0.985 | 67.415 |
| 18 | 1.85 | 28.85 | / | / | / | 1.0 | / | / | / | / | / | / | / | 0.985 | 67.315 |
| 19 | 13.65 | 17.15 | / | / | / | 0.3 | 0.1 | / | / | / | / | / | / | 0.985 | 67.815 |
| 20 | 13.35 | 17.15 | / | / | / | 0.47 | 0.25 | / | / | / | / | / | / | 0.985 | 67.795 |
| 21 | 10.85 | 21.15 | / | / | / | 0.53 | 0.5 | / | / | / | / | / | / | 0.985 | 65.985 |
| 22 | 10.85 | 21.15 | / | / | / | 1.0 | 0.7 | / | / | / | / | / | / | 0.985 | 65.315 |
| 23 | 7.85 | 23.15 | / | / | / | 0.49 | / | 0.2 | / | / | / | / | / | 0.985 | 67.325 |
| 24 | 7.85 | 23.15 | / | / | / | 0.51 | / | 0.45 | / | / | / | / | / | 0.985 | 67.055 |
| 25 | 5.85 | 24.15 | / | 2 | / | 0.53 | / | 0.6 | / | / | / | / | / | 1 | 65.87 |
| 26 | 5.85 | 24.15 | 0.3 | 1.7 | / | 0.55 | / | 0.8 | / | / | / | / | / | 1.1 | 65.55 |
| 27 | 9.85 | 20.15 | 0.3 | 1.2 | / | 0.57 | / | / | 0.1 | / | 0.01 | / | / | 1.2 | 66.62 |
| 28 | 9.85 | 20.15 | 0.1 | 1.4 | / | 0.28 | / | / | 0.25 | / | 0.015 | / | / | 1.2 | 66.755 |
| 29 | 11.15 | 20.15 | / | 0.5 | / | 0.32 | / | / | 0.28 | / | 0.013 | / | / | 0.985 | 66.602 |
| 30 | 11.15 | 20.15 | / | 0.5 | / | 0.36 | / | / | 0.3 | / | 0.018 | / | / | 0.985 | 66.537 |
| 31 | 6.15 | 23.15 | 0.1 | 1.5 | / | 0.7 | / | / | 0.35 | / | / | / | / | 0.985 | 67.065 |
| 32 | 6.15 | 23.15 | 0.2 | 1.4 | / | 0.8 | / | / | 0.4 | / | / | / | / | 0.985 | 66.915 |
| 32.1 | 7.85 | 23.15 | 0.5 | / | / | 0.85 | / | / | 0.25 | / | 0.01 | / | / | 0.985 | 66.405 |
| 32.2 | 7.85 | 23.15 | / | 1 | / | 0.95 | / | / | 0.3 | / | 0.013 | / | / | 0.985 | 65.752 |
| 33 | 6.85 | 24.15 | 0.3 | 0.7 | / | 1.0 | / | / | / | 1 | / | / | / | 0.985 | 65.015 |
| 34 | 6.85 | 24.15 | 0.3 | 0.7 | / | 0.25 | 0.1 | 0.2 | / | / | / | / | / | 0.985 | 66.465 |
| 35 | 6.85 | 24.15 | 0.3 | 0.7 | / | 0.4 | 0.2 | 0.4 | / | / | / | / | / | 0.985 | 66.015 |
| 36 | 5.85 | 24.15 | 0.2 | 0.8 | / | 0.5 | 0.4 | 0.6 | / | / | / | / | / | 0.985 | 66.515 |
| 37 | 5.85 | 24.15 | 0.2 | 0.8 | / | 1.0 | 0.8 | 1 | / | / | / | / | / | 0.985 | 65.215 |
| 38 | 12.35 | 19.15 | / | / | / | 0.3 | 0.2 | / | 0.1 | / | / | / | / | 0.985 | 66.915 |
| 39 | 11.75 | 19.15 | / | / | / | 1.0 | 0.4 | / | 0.25 | / | / | / | / | 0.985 | 66.465 |
| 40 | 12.35 | 17.15 | 0.3 | 0.7 | / | 0.3 | / | 0.05 | 0.1 | / | / | / | / | 0.985 | 68.065 |
| 41 | 12.35 | 17.15 | 0.3 | 0.7 | / | 0.35 | / | 0.1 | 0.25 | / | / | / | / | 0.985 | 67.815 |
| 42 | 11.75 | 19.15 | / | / | / | 0.45 | / | 0.3 | 0.28 | / | / | / | / | 0.985 | 67.085 |
| 43 | 11.75 | 19.15 | / | / | / | 0.6 | / | 0.6 | 0.3 | / | / | / | / | 0.985 | 66.615 |
| 44 | 12.85 | 18.15 | / | / | / | 0.25 | 0.35 | 0.02 | 0.15 | / | / | / | / | 0.985 | 67.245 |
| 45 | 12.85 | 18.15 | / | / | / | 0.28 | 0.45 | 0.03 | 0.25 | / | / | / | / | 0.985 | 67.005 |
| 46 | 11.75 | 19.15 | / | / | / | 0.36 | 0.48 | 0.1 | 0.26 | / | / | / | / | 0.985 | 66.915 |
| 47 | 11.75 | 19.15 | / | / | / | 0.38 | 0.5 | 0.03 | 0.27 | / | / | / | / | 0.985 | 66.935 |
| 48 | 9.85 | 20.15 | 0.2 | 1 | / | 0.55 | 0.55 | 0.02 | 0.28 | / | / | / | / | 0.985 | 66.415 |
| 49 | 9.85 | 20.15 | 0.2 | 1 | / | 0.6 | 0.58 | 0.03 | 0.29 | / | / | / | / | 0.985 | 66.315 |
| 49.1 | 6.15 | 23.15 | / | 2 | / | 0.7 | 0.35 | 0.02 | 0.25 | / | / | / | / | 0.985 | 66.395 |
| 49.2 | 6.15 | 23.15 | / | 1 | / | 0.8 | 0.45 | 0.02 | 0.25 | / | / | / | / | 0.985 | 67.195 |
| 49.3 | 5.85 | 25.15 | 1 | | / | 0.9 | 0.45 | 0.03 | 0.3 | / | / | / | / | 0.985 | 65.335 |
| 49.4 | 5.85 | 25.15 | / | / | / | 1 | 0.5 | 0.03 | 0.3 | / | / | / | / | 0.985 | 66.185 |
| 50 | 9.55 | 20.15 | 0.2 | 1 | 1 | 0.3 | / | 0.05 | / | / | / | 0.02 | 0.05 | 0.985 | 66.695 |
| 51 | 11.75 | 19.15 | / | / | 1 | 0.45 | / | 0.12 | / | / | / | 0.05 | 0.02 | 0.985 | 66.475 |
| 52 | 12.85 | 18.15 | / | / | 1 | 0.6 | / | 0.15 | / | / | / | 0.05 | 0.05 | 0.985 | 66.165 |
| 55 | 6.85 | 24.15 | / | / | / | 0.1 | 0.1 | 0.2 | / | / | / | / | / | 0.985 | 67.615 |
| 56 | 6.85 | 24.15 | / | / | / | 0.2 | 0.1 | 0.2 | / | / | / | / | / | 0.985 | 67.515 |
| 57 | 15.15 | 15.85 | / | / | / | 0.25 | 0.1 | 0.2 | / | / | / | / | / | 0.985 | 67.465 |
| 58 | 22.15 | 8.85 | / | / | / | 0.25 | 0.1 | 0.2 | / | / | / | / | / | 0.985 | 67.465 |

### Example 1

The neodymium-iron-boron magnet materials were prepared as follows:

(1) Melting and casting process: according to the formulations shown in Table 1, the prepared raw materials were put into a crucible made of alumina and vacuum melted in a high-frequency vacuum induction melting furnace and in a vacuum of 5×10⁻² Pa at a temperature of 1500° C. or less. After vacuum melting, the melting furnace was fed with Ar gas to make the air pressure reach 5.5×10⁴ Pa and then casting was carried out, and a cooling rate of 10²° C./sec-10⁴° C./sec was used to obtain the quench alloy.

(2) Hydrogen decrepitation process: the melting furnace with quench alloy placed therein was evacuated at room temperature, and then hydrogen gas of 99.9% purity was passed into the furnace for hydrogen decrepitation to maintain the hydrogen pressure at 0.15 MPa; after sufficient hydrogen absorption, it was sufficiently dehydrogenated by heating up while vacuum-pumping; then it was cooled and the powder after hydrogen decrepitation was taken out.

(3) Micro-pulverization process: the powder after hydrogen decrepitation was pulverized by jet mill for 3 hours in nitrogen atmosphere with oxidizing gas content of 150 ppm or less and under the condition of the pressure of 0.38 MPa in the pulverization chamber, and fine powder was obtained. The oxidizing gas refers to oxygen or moisture.

(4) Zinc stearate was added to the powder after jet mill pulverization, and the addition amount of zinc stearate was 0.12% by weight of the mixed powder, and then it was mixed thoroughly by using a V-mixer.

(5) Magnetic field forming process: a rectangular oriented magnetic field forming machine was used to conduct primary forming of the above-mentioned powder with zinc stearate into a cube with sides of 25 mm in an orientation magnetic field of 1.6 T and a forming pressure of 0.35 ton/cm²; after the primary forming, it was demagnetized in a magnetic field of 0.2 T. In order to prevent the formed body after the primary forming from contacting with air, it was sealed, and then secondary forming was carried out at a pressure of 1.3 ton/cm² using a secondary forming machine (isostatic forming machine).

(6) Sintering process: each formed body was moved to a sintering furnace for sintering, the sintering was maintained under a vacuum of 5×10⁻³ Pa and at a temperature of 300° C. and 600° C. for 1 hour, respectively; then, sintered at a temperature of 1040° C. for 2 hours; and then Ar gas was passed in to make the air pressure reach 0.1 MPa, and cooled to room temperature to obtain sintered body.

(7) Aging treatment process: the sintered body was heat treated in high purity Ar gas at a temperature of 500° C. for 3 hours and then cooled to room temperature and taken out.

### Example 53 Using Dy Grain Boundary Diffusion Method

The raw material composition of Example 1 in Table 1 was first prepared according to the preparation of the sintered body of Example 1 to obtain a sintered body, followed by grain boundary diffusion, and then aging treatment. Wherein the process of aging treatment is the same as in Example 1, and the processing procedure of grain boundary diffusion is as follows:

The sintered body was processed into a magnet with a diameter of 20 mm and a thickness of less than 3 mm, and the thickness direction is the magnetic field orientation direction, after the surface was cleaned, the raw materials formulated with Dy fluoride were used to coat the magnet through a full spray, and the coated magnet was dried, and the metal with Tb element was attached to the magnet surface by sputtering in a high-purity Ar gas atmosphere, diffusion heat treatment was carried out at a temperature of 850° C. for 24 hours. Cooled to room temperature.

### Example 54 Using Tb Grain Boundary Diffusion Method

The number 1 in Table 1 was first prepared according to the preparation of the sintered body of Example 1 to obtain a sintered body, followed by grain boundary diffusion, and then aging treatment. Wherein the process of aging treatment is the same as in Example 1, and the processing procedure of grain boundary diffusion is as follows:

The sintered body was processed into a magnet with a diameter of 20 mm and a thickness of less than 7 mm, and the thickness direction is the magnetic field orientation direction, after the surface was cleaned, the raw materials formulated with Tb fluoride were used to coat the magnet through a full spray, and the coated magnet was dried, and the metal with Tb element was attached to the magnet surface by sputtering in a high-purity Ar gas atmosphere, diffusion heat treatment was carried out at a temperature of 850° C. for 24 hours. Cooled to room temperature.

### Effect Example

The magnetic properties and compositions of the neodymium-iron-boron magnet materials made in Examples 1-54 and Comparative Examples 55-58 were measured, and the crystalline phase structure of the magnets was observed using a field emission electron probe microanalyzer (FE-EPMA).

(1) Magnetic properties evaluation: The magnetic properties were examined using the NIM-10000H type BH bulk rare earth permanent magnet nondestructive measurement system in National Institute of Metrology, China. The following Table 2 indicates the magnetic property testing results.

TABLE 2

| | | | Absolute | Absolute | Absolute |
|---|---|---|---|---|---|
| | | | value of Hcj | value of Hcj | value of Hcj |
| | | | temperature | temperature | temperature |
| | | | coefficient at | coefficient at | coefficient at |
| No. | Br(kGs) | Hcj(kOe) | 80° C. | 150° C. | 180° C. |
| 1 | 14.12 | 18.24 | 0.689 | / | / |
| 2 | 14.09 | 18.38 | 0.685 | / | / |
| 3 | 14.34 | 18.07 | 0.692 | / | / |
| 4 | 14.21 | 18.55 | 0.672 | / | / |
| 5 | 13.90 | 19.52 | 0.668 | / | / |
| 6 | 13.79 | 19.88 | 0.664 | / | / |
| 7 | 13.81 | 20.04 | 0.648 | / | / |
| 8 | 13.79 | 20.18 | 0.642 | / | / |
| 9 | 13.72 | 20.79 | 0.638 | / | / |
| 10 | 13.74 | 20.84 | 0.632 | / | / |
| 11 | 13.91 | 20.88 | 0.631 | / | / |
| 12 | 13.93 | 21.27 | 0.612 | / | / |
| 13 | 13.88 | 21.52 | 0.609 | / | / |
| 14 | 13.73 | 22.66 | 0.591 | / | / |
| 15 | 13.58 | 23.55 | 0.577 | / | / |
| 16 | 13.46 | 24.52 | / | 0.532 | |
| 17 | 13.38 | 25.01 | / | 0.518 | / |
| 18 | 13.23 | 25.8 | / | 0.513 | / |
| 19 | 14.07 | 19.03 | 0.673 | / | / |
| 20 | 13.92 | 20.18 | 0.649 | / | / |
| 21 | 13.05 | 24.07 | / | 0.556 | / |
| 22 | 12.45 | 28.23 | / | 0.503 | / |
| 23 | 13.98 | 21.88 | 0.623 | / | / |
| 24 | 13.75 | 22.61 | 0.617 | / | / |
| 25 | 12.7 | 30.6 | / | / | 0.437 |
| 26 | 12.5 | 30.9 | / | / | 0.435 |
| 27 | 13.35 | 26.2 | / | 0.513 | / |
| 28 | 13.4 | 24.64 | / | 0.530 | / |
| 29 | 13.6 | 21.75 | 0.605 | / | / |
| 30 | 13.57 | 22.03 | 0.619 | / | / |
| 31 | 13.82 | 26.32 | / | 0.509 | / |
| 32 | 13.75 | 26.91 | / | 0.506 | / |
| 32.1 | 13.21 | 25.65 | / | 0.518 | |
| 32.2 | 12.79 | 28.89 | / | 0.496 | |
| 33 | 12.7 | 28.63 | / | 0.495 | / |
| 34 | 13.3 | 24.53 | / | 0.535 | / |
| 35 | 13.1 | 26.03 | / | 0.519 | / |
| 36 | 12.95 | 28.33 | / | 0.502 | / |
| 37 | 11.72 | 33.83 | / | / | 0.422 |
| 38 | 13.66 | 20.47 | 0.638 | / | / |
| 39 | 12.9 | 25.9 | / | 0.513 | / |
| 40 | 13.94 | 21.63 | 0.623 | / | / |
| 41 | 13.9 | 22.19 | 0.624 | / | / |
| 42 | 13.93 | 20.97 | 0.633 | / | / |
| 43 | 13.7 | 22.72 | 0.611 | / | / |
| 44 | 13.68 | 20.38 | 0.641 | / | / |
| 45 | 13.47 | 21.17 | 0.629 | / | / |
| 46 | 13.33 | 22.24 | 0.617 | / | / |
| 47 | 13.51 | 22.48 | 0.615 | / | / |
| 48 | 13.09 | 27.27 | / | 0.516 | / |
| 49 | 13.05 | 27.79 | / | 0.512 | / |
| 49.1 | 12.89 | 31.2 | / | / | 0.439 |
| 49.2 | 13.18 | 28.28 | / | 0.492 | / |
| 49.3 | 12.73 | 28.73 | / | 0.488 | / |
| 49.4 | 12.68 | 29.43 | / | 0.471 | / |
| 50 | 13.43 | 23.51 | 0.573 | / | / |
| 51 | 12.85 | 25.57 | / | 0.518 | / |
| 52 | 12.68 | 26.37 | / | 0.512 | / |
| 53 | 13.95 | 24.5 | / | 0.535 | / |
| 54 | 13.98 | 29.3 | / | 0.472 | / |
| 55 | 13.85 | 18.69 | 0.668 | / | / |
| 56 | 13.82 | 18.75 | 0.666 | / | / |
| 57 | 13.95 | 17.51 | 0.672 | / | / |
| 58 | 14.19 | 15.79 | 0.749 | / | / |

(2) Composition determination: the components were determined using a high-frequency inductively coupled plasma emission spectrometer (ICP-OES). The following Table 3 shows the results of the composition testing.

TABLE 3
Composition test results (wt. %)

| No. | Nd | Pr | Dy | Tb | Ho | Ga | Cu | Al | Zr | Co | Mn | Zn | Mo | B | Fe |
|---|---|---|---|---|---|---|---|---|---|---|---|---|---|---|---|
| 1 | 13.848 | 17.151 | / | / | / | 0.248 | / | / | / | / | / | / | / | 0.984 | 67.769 |
| 2 | 13.856 | 17.150 | / | / | / | 0.268 | / | / | / | / | / | / | / | 0.987 | 67.784 |
| 3 | 12.451 | 18.132 | / | / | / | 0.291 | / | / | / | / | / | / | / | 0.983 | 68.143 |
| 4 | 12.89 | 18.148 | / | / | / | 0.312 | / | / | / | / | / | / | / | 0.983 | 67.667 |
| 5 | 12.345 | 19.149 | / | / | / | 0.332 | / | / | / | / | / | / | / | 0.986 | 67.188 |
| 6 | 12.851 | 19.149 | / | / | / | 0.352 | / | / | / | / | / | / | / | 0.984 | 66.664 |
| 7 | 11.355 | 20.147 | / | / | / | 0.371 | / | / | / | / | / | / | / | 0.987 | 67.14 |
| 8 | 11.352 | 20.148 | / | / | / | 0.392 | / | / | / | / | / | / | / | 0.983 | 67.125 |
| 9 | 10.851 | 21.146 | / | / | / | 0.413 | / | / | / | / | / | / | / | 0.983 | 66.607 |
| 10 | 10.651 | 21.148 | / | / | / | 0.433 | / | / | / | / | / | / | / | 0.986 | 66.782 |
| 11 | 8.851 | 22.148 | / | / | / | 0.452 | / | / | / | / | / | / | / | 0.949 | 67.6 |
| 12 | 7.852 | 23.149 | / | / | / | 0.472 | / | / | / | / | / | / | / | 0.956 | 67.571 |
| 13 | 6.853 | 24.151 | / | / | / | 0.492 | / | / | / | / | / | / | / | 0.969 | 67.535 |
| 14 | 5.852 | 25.152 | / | / | / | 0.589 | / | / | / | / | / | / | / | 0.982 | 67.425 |
| 15 | 4.852 | 26.151 | / | / | / | 0.712 | / | / | / | / | / | / | / | 0.991 | 67.294 |
| 16 | 3.848 | 27.152 | / | / | / | 0.82 | / | / | / | / | / | / | / | 0.985 | 67.195 |
| 17 | 2.848 | 27.851 | / | / | / | 0.912 | / | / | / | / | / | / | / | 0.984 | 67.405 |
| 18 | 1.852 | 28.852 | / | / | / | 1.03 | / | / | / | / | / | / | / | 0.987 | 67.279 |
| 19 | 13.651 | 17.149 | / | / | / | 0.301 | 0.1 | / | / | / | / | / | / | 0.983 | 67.816 |
| 20 | 13.348 | 17.147 | / | / | / | 0.471 | 0.25 | / | / | / | / | / | / | 0.983 | 67.801 |
| 21 | 10.848 | 21.148 | / | / | / | 0.531 | 0.5 | / | / | / | / | / | / | 0.984 | 65.989 |
| 22 | 10.849 | 21.148 | / | / | / | 1.02 | 0.7 | / | / | / | / | / | / | 0.987 | 65.296 |
| 23 | 7.849 | 23.148 | / | / | / | 0.491 | / | 0.202 | / | / | / | / | / | 0.983 | 67.327 |
| 24 | 7.849 | 23.147 | / | / | / | 0.512 | / | 0.451 | / | / | / | / | / | 0.983 | 67.058 |
| 25 | 5.848 | 24.148 | / | 2.001 | / | 0.531 | / | 0.603 | / | / | / | / | / | 1.02 | 65.849 |
| 26 | 5.848 | 24.148 | 0.301 | 1.701 | / | 0.551 | / | 0.801 | / | / | / | / | / | 1.11 | 65.54 |
| 27 | 9.848 | 20.148 | 0.302 | 1.21 | / | 0.572 | / | / | 0.1 | / | 0.01 | / | / | 1.19 | 66.62 |
| 28 | 9.848 | 20.149 | 0.101 | 1.42 | / | 0.281 | / | / | 0.25 | / | 0.015 | / | / | 1.18 | 66.756 |
| 29 | 11.149 | 20.154 | / | 0.502 | / | 0.323 | / | / | 0.28 | / | 0.013 | / | / | 0.984 | 66.595 |
| 30 | 11.148 | 20.151 | / | 0.503 | / | 0.361 | / | / | 0.3 | / | 0.018 | / | / | 0.987 | 66.532 |
| 31 | 6.147 | 23.152 | 0.101 | 1.492 | / | 0.703 | / | / | 0.35 | / | / | / | / | 0.983 | 67.072 |
| 32 | 6.148 | 23.152 | 0.202 | 1.402 | / | 0.804 | / | / | 0.4 | / | / | / | / | 0.983 | 66.909 |
| 32.1 | 7.846 | 23.152 | 0.51 | / | / | 0.848 | / | / | 0.248 | / | 0.02 | / | / | 0.984 | 66.392 |
| 32.2 | 7.851 | 23.15 | / | 1.02 | / | 0.951 | / | / | 0.301 | / | 0.014 | / | / | 0.984 | 65.729 |
| 33 | 6.847 | 24.151 | 0.303 | 0.702 | / | 1.03 | / | / | / | 1 | / | / | / | 0.986 | 64.981 |
| 34 | 6.846 | 24.152 | 0.301 | 0.703 | / | 0.252 | 0.102 | 0.202 | / | / | / | / | / | 0.984 | 66.458 |
| 35 | 6.848 | 24.151 | 0.302 | 0.704 | / | 0.402 | 0.205 | 0.402 | / | / | / | / | / | 0.984 | 66.002 |
| 36 | 5.845 | 24.152 | 0.202 | 0.802 | / | 0.502 | 0.405 | 0.602 | / | / | / | / | / | 0.987 | 66.503 |
| 37 | 5.85 | 24.152 | 0.203 | 0.802 | / | 1.03 | 0.803 | 1.02 | / | / | / | / | / | 0.983 | 65.157 |
| 38 | 12.347 | 19.153 | / | / | / | 0.302 | 0.202 | / | 0.1 | / | / | / | / | 0.983 | 66.913 |
| 39 | 11.748 | 19.151 | / | / | / | 1.02 | 0.402 | / | 0.25 | / | / | / | / | 0.984 | 66.445 |
| 40 | 12.347 | 17.149 | 0.301 | 0.703 | / | 0.303 | / | 0.04 | 0.1 | / | / | / | / | 0.987 | 68.07 |
| 41 | 12.35 | 17.145 | 0.301 | 0.705 | / | 0.351 | / | 0.102 | 0.25 | / | / | / | / | 0.983 | 67.813 |
| 42 | 11.746 | 19.146 | / | / | / | 0.451 | / | 0.301 | 0.28 | / | / | / | / | 0.983 | 67.093 |
| 43 | 11.748 | 19.149 | / | / | / | 0.602 | / | 0.601 | 0.3 | / | / | / | / | 0.986 | 66.614 |
| 44 | 12.848 | 18.148 | / | / | / | 0.251 | 0.352 | 0.02 | 0.15 | / | / | / | / | 0.984 | 67.247 |
| 45 | 12.848 | 18.146 | / | / | / | 0.281 | 0.451 | 0.03 | 0.25 | / | / | / | / | 0.987 | 67.007 |
| 46 | 11.751 | 19.149 | / | / | / | 0.362 | 0.481 | 0.101 | 0.26 | / | / | / | / | 0.984 | 66.912 |
| 47 | 11.752 | 19.148 | / | / | / | 0.38 | 0.502 | 0.02 | 0.27 | / | / | / | / | 0.987 | 66.941 |
| 48 | 9.852 | 20.147 | 0.202 | 1.01 | / | 0.55 | 0.552 | 0.02 | 0.28 | / | / | / | / | 0.983 | 66.404 |
| 49 | 9.851 | 20.146 | 0.203 | 1.02 | / | 0.6 | 0.581 | 0.03 | 0.29 | / | / | / | / | 0.983 | 66.296 |
| 49.1 | 6.149 | 23.151 | / | 2.01 | / | 0.701 | 0.351 | 0.01 | 0.251 | / | / | / | / | 0.984 | 66.393 |
| 49.2 | 6.151 | 23.151 | / | 1.02 | / | 0.791 | 0.452 | 0.01 | 0.252 | / | / | / | / | 0.986 | 67.187 |
| 49.3 | 5.852 | 25.152 | 1.03 | / | / | 0.892 | 0.451 | 0.03 | 0.301 | / | / | / | / | 0.984 | 65.308 |
| 49.4 | 5.851 | 25.152 | / | / | / | 1.02 | 0.501 | 0.04 | 0.302 | / | / | / | / | 0.984 | 66.15 |
| 50 | 9.549 | 20.148 | 0.203 | 1.03 | 1.02 | 0.3 | / | 0.05 | / | / | / | 0.01 | 0.06 | 0.986 | 66.644 |
| 51 | 11.747 | 19.148 | / | / | 1.01 | 0.45 | / | 0.12 | / | / | / | 0.06 | 0.03 | 0.984 | 66.451 |
| 52 | 12.848 | 18.146 | / | / | 0.99 | 0.6 | / | 0.15 | / | / | / | 0.04 | 0.03 | 0.987 | 66.209 |
| 53 | 13.849 | 17.152 | 0.421 | / | / | 0.247 | / | / | / | / | / | / | / | 0.984 | 67.347 |
| 54 | 13.848 | 17.151 | / | 0.501 | / | 0.249 | / | / | / | / | / | / | / | 0.984 | 67.267 |
| 55 | 6.846 | 24.148 | / | / | / | 0.1 | 0.101 | 0.2 | / | / | / | / | / | 0.984 | 67.621 |
| 56 | 6.845 | 24.148 | / | / | / | 0.2 | 0.103 | 0.2 | / | / | / | / | / | 0.987 | 67.517 |
| 57 | 15.148 | 15.849 | / | / | / | 0.25 | 0.102 | 0.2 | / | / | / | / | / | 0.983 | 67.468 |
| 58 | 22.146 | 8.849 | / | / | / | 0.25 | 0.102 | 0.2 | / | / | / | / | / | 0.983 | 67.47 |

FE-EPMA inspection: the perpendicularly oriented surface of the magnet material of Example 23 was polished and inspected using a field emission electron probe micro-analyzer (FE-EPMA) (Japan Electronics Corporation (JEOL), 8530F). The main elements analyzed are Pr, Nd, Ga, Zr, O, and the elements at the grain boundary and the intergranular triangular region were quantitatively analyzed.

FIG. 1 shows the distribution diagram of each element in the neodymium-iron-boron magnet material. From FIG. 1, it can be seen that the Pr and Nd elements are mainly distributed in the main phase, some rare earths also appear in the grain boundary, and the element Ga is also distributed in the main phase and the crystal phase, the element Zr is distributed at the grain boundary.

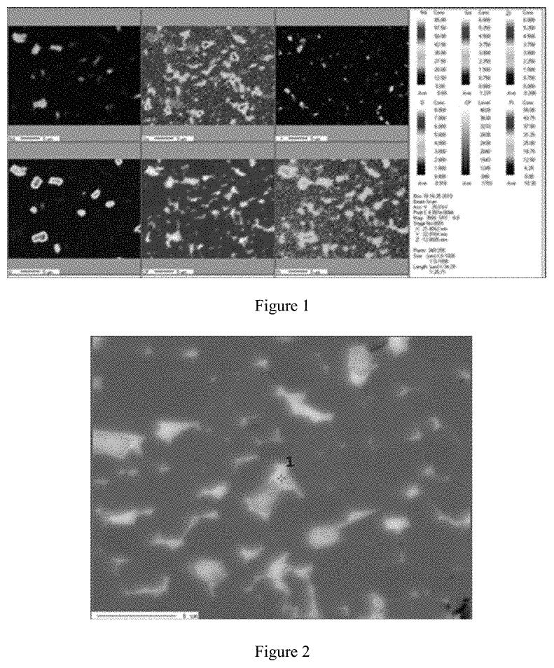

FIG. 2 shows the element distribution at the grain boundary of the neodymium-iron-boron magnet material of Example 23, and the elements at the grain boundary were quantitatively analyzed by taking the point marked by 1 in FIG. 2, the results are shown in Table 4 below:

TABLE 4

| Pr | Nd | Ga | Zr | O | Fe |
|---|---|---|---|---|---|
| (wt. %) | (wt. %) | (wt. %) | (wt. %) | (wt. %) | (wt. %) |
| 37.8 | 28.2 | 5.26 | 0.08 | 0.69 | Bal |

From the above data, it can be clearly seen that Pr and Nd exist in the form of rare earth rich phases and oxides in the grain boundaries, α-Pr and α-Nd, Pr₂O₃, Nd₂O₃ and NdO, respectively, and Ga occupies a certain content of about 5.26 wt. % at the grain boundaries in addition to the main phase, Zr is dispersed in the whole region as a high melting point element.

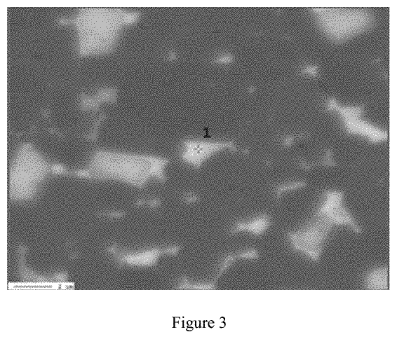

FIG. 3 shows the element distribution of the intergranular triangular region of the neodymium-iron-boron magnet materials of Example 23, and the elements in the intergranular triangular region were quantitatively analyzed by taking the point marked by 1 in FIG. 3, and the results are shown in Table 5 below:

TABLE 5

| Pr | Nd | Ga | Zr | O | Fe |
|---|---|---|---|---|---|
| (wt. %) | (wt. %) | (wt. %) | (wt. %) | (wt. %) | (wt. %) |
| 27.8 | 29.5 | 4.95 | 0.039 | 0.95 | Bal |

In the intergranular triangular region, Pr and Nd elements are distributed in it, in the formulations with high Pr, it is clearly found that the content of Pr is obviously lower than that of Nd in the intergranular triangular region, although some rare earths are enriched here, the enrichment degree of Pr is less than that of Nd, which is one of the reasons why high Pr and Ga work together to improve the coercivity. At the same time, there is a partial distribution of O and Ga therein.

1. A raw material composition of neodymium-iron-boron magnet material, which comprises the following components by mass percentage:
29.5-32% of R′, wherein R′ refers to rare earth elements, R′ comprises Pr and Nd; wherein, Pr≥17.15%;
0.25-1.05% of Ga;
0.9-1.2% of B;
64-69% of Fe;
the percentage refers to the mass percentage of the content of each component in the total mass of the raw material composition of neodymium-iron-boron magnet material.

2. The raw material composition according to claim 1, wherein,
the content of Pr is 17.15-29%
or, the content of Ga is 0.25-1%.

3. The raw material composition according to claim 1, which comprises the following components by mass percentage: 29.5-32% of R′, R′ refers to rare earth elements, R′ comprises Pr and Nd; wherein, Pr≥17.15%; 0.25-1.05% of Ga; Cu≥0.35%; Al≤0.03%; 0.25-0.3% of Zr; 0.9-1.2% of B; 64-69% of Fe.

4. The raw material composition according to claim 1, which comprises the following components by mass percentage: 29.5-32% of R′, R′ refers to rare earth elements, R′ comprises Pr and Nd; wherein, Pr≥17.15%; 0.25-1.05% of Ga; Mn≤0.02%; 0.25-0.3% of Zr; 0.9-1.2% of B; 64-69% of Fe.

5. A preparation method for neodymium-iron-boron magnet material, which employs the raw material composition according to claim 1 for preparing;
the preparation method comprises the following steps: subjecting the molten liquid of the raw material composition to
melting and casting,
hydrogen decrepitation,
forming,
sintering, and
aging treatment.

6. A neodymium-iron-boron magnet material, which is prepared by the preparation method according to claim 5.

7. A neodymium-iron-boron magnet material, which comprises the following components by mass percentage: 29.5-32% of R′, R′ comprises Pr and Nd; wherein, Pr≥17.15%;
0.245-1.05% of Ga;
0.9-1.2% of B;
64-69% of Fe;
the percentage refers to the mass percentage of the content of each component in the total mass of the neodymium-iron-boron magnet material.

8. The neodymium-iron-boron magnet material according to claim 7, wherein, the content of Pr is 17.15-29%
or, the content of Ga is 0.247-1.03%.

9. A neodymium-iron-boron magnet material, wherein, in the intergranular triangle region of the neodymium-iron-boron magnet material, the ratio of the total mass of Pr and Ga to the total mass of Nd and Ga≤1.0;
at the grain boundary of the neodymium-iron-boron magnet material, the ratio of the total mass of Pr and Ga to the total mass of Nd and Ga≥0.1.

10. A use of the neodymium-iron-boron magnet material according to claim 7 as an electronic component in a motor.

11. The raw material composition according to claim 1, wherein, the content of Nd is 1.85-14%;
or, the ratio of the mass of Nd to the total mass of R′ is 0.5 or less;
or, the content of B is 0.95-1.2%;
or, the content of Fe is 65-68.3%;
or, R′ further comprises other rare earth elements other than Pr and Nd.

12. The raw material composition according to claim 1, wherein, R′ further comprises RH, RH refers to heavy rare earth elements; RH comprises one or more of Dy, Tb and Ho; the mass ratio of RH to R′ is <0.253; the content of RH is 1-2.5%.

13. The raw material composition according to claim 12, wherein,
when RH contains Tb, the content of Tb is 0.5%-2%;
or, when RH contains Dy, the content of Dy is 1% or less;
or, when RH contains Ho, the content of Ho is 0.8-2%.

14. The raw material composition according to claim 1, wherein,
the raw material composition of neodymium-iron-boron magnet material further comprises Cu; the content of Cu is 0.1-0.8%;
or, the raw material composition of neodymium-iron-boron magnet material further comprises Al; the content of Al is 1% or less;
or, the raw material composition of neodymium-iron-boron magnet material further comprises Zr; the content of Zr is 0.4% or less;
or, the raw material composition of neodymium-iron-boron magnet material further comprises Co; the content of Co is 0.5-2%;
or, the raw material composition of neodymium-iron-boron magnet material further comprises Mn; the content of Mn is 0.02% or less;
or, the raw material composition of neodymium-iron-boron magnet material further comprises one or more of Zn, Ag, In, Sn, V, Cr, Mo, Ta, Hf and W.

15. The preparation method for neodymium-iron-boron magnet material according to claim 5, wherein, after sintering and before the aging treatment, a grain boundary diffusion treatment is further carried out.

16. The neodymium-iron-boron magnet material according to claim 7, wherein,
the content of Nd is 1.85-14%;
or, the ratio of the mass of Nd to the total mass of R′ is <0.5;
or, the content of B is 0.95-1.2%;
or, the content of Fe is 64.8-68.2%;
or, R′ further comprises other rare earth elements other than Pr and Nd.

17. The neodymium-iron-boron magnet material according to claim 7, wherein, R′ further comprises RH, RH refers to heavy rare earth elements, RH comprises one or more of Dy, Tb and Ho; the mass ratio of RH and R′ is <0.253; the content of RH is 1-2.5%.

18. The neodymium-iron-boron magnet material according to claim 17, wherein,
when RH comprises Tb, the content of Tb is 0.5-2.01%;
or, when RH comprises Dy, the content of Dy is 1.05% or less;
or, when RH comprises Ho, the content of Ho is 0.8-2%.

19. The neodymium-iron-boron magnet material according to claim 7, wherein,
the neodymium-iron-boron magnet material further comprises Cu; the content of Cu is 0.1-0.9%;
or, the neodymium-iron-boron magnet material further comprises Al; the content of Al is 1.1 wt. % or less;
or, the neodymium-iron-boron magnet material further comprises Zr; the content of Zr is 0.4% or less;
or, the neodymium-iron-boron magnet material further comprises Co; the content of Co is 0.5-2%;
or, the neodymium-iron-boron magnet material further comprises Mn; the content of Mn is 0.02% or less;
or, the neodymium-iron-boron magnet material further comprises O; the content of O is 0.13% or less;
or, the neodymium-iron-boron magnet material further comprises one or more of Zn, Ag, In, Sn, V, Cr, Mo, Ta, Hf and W.

20. The neodymium-iron-boron magnet material according to claim 7, wherein, in the intergranular triangle region of the neodymium-iron-boron magnet material, the ratio of the total mass of Pr and Ga to the total mass of Nd and Ga≤1.0;
at the grain boundary of the neodymium-iron-boron magnet material, the ratio of the total mass of Pr and Ga to the total mass of Nd and Ga≥0.1.
